(19) United States
(12) Patent Application Publication
(10) Pub. No.: US 2015/0170242 A1
(43) Pub. Date: Jun. 18, 2015

(54) Process by which files to be printed on 3D printers can be secured, along with digital rights to reproduce these objects

(71) Applicant: Keith Glen Bjorndahl, Regina (CA)

(72) Inventor: Keith Glen Bjorndahl, Regina (CA)

(21) Appl. No.: 14/103,889

(22) Filed: Dec. 12, 2013

(51) Int. Cl. G06Q 30/06

(52) U.S. Cl. CPC G06Q 30/0621; G06Q 2220/16

(57) ABSTRACT

A process by which a network service can be used to secure the rights to print 3D copies of items protected by trademark or other protection. Once rights are secured, the process can make a file available so the 3D printer can recreate the object, but not more copies than allowed by the license. The file will have metadata included to allow limitations to be placed on how many times it can be used to create the 3D object on the 3D printer.

### BACKGROUND

As 3D printers enter the general marketplace, certain trademarked or otherwise protected items may be made available for users of these computers to reproduce. A consumer who owns or has access to a 3D printer could purchase rights to reproduce these trademarked items on the 3D printer from a third party network service provider. The network service provider will be responsible for payment to the trademark holder.

### DESCRIPTION

A mechanism by which the rights to print certain materials on 3D printers can be purchased over a public network, and files defining the 3D object may be encrypted, transmitted, and used at the location of a 3D printer to print the object. The encrypted file will include the definition of the 3D object to be printed, along with metadata indicating among other items, the purchaser of the rights to print, a digital serial number, print scale, and optionally a limit on number of 3D reproductions that are licensed for printing.

Software running on the computer of the individual or corporation who purchased the rights to reproduce the 3D image will decrypt the file, and allow the object to be printed within the constraints defined in the metadata. Once the licensed number of copies of the 3D object have been printed, the software will prohibit additional copies from being produced using that file. As each licensed copy is produced, network web services will be used to update the remaining allowable items to print.

This process will make use of existing data encryption algorithms and network transfer techniques. The current 3D printing environment is starting to see some movement in the file sharing arena, but there is currently no processes in place that allow this to be monetized, or the rights given to legally reproduce items protected by trademark or other protections.

### EXAMPLE OF INTENDED USE

A parent wishes to obtain an action figure for their child. Instead of ordering on line or driving to a nearby toy store, the parent may purchase the rights to produce their own copy of the action figure on a nearby 3D printer and download the file required to do so, but may only produce as may copies of the action figure as they have purchased rights to.

### Drawings

FIG. 1—Process flow diagram describing the stakeholders and how the process interacts with them

FIG. 2—Flow chart describing the design of the 3D print authorizing 3D process

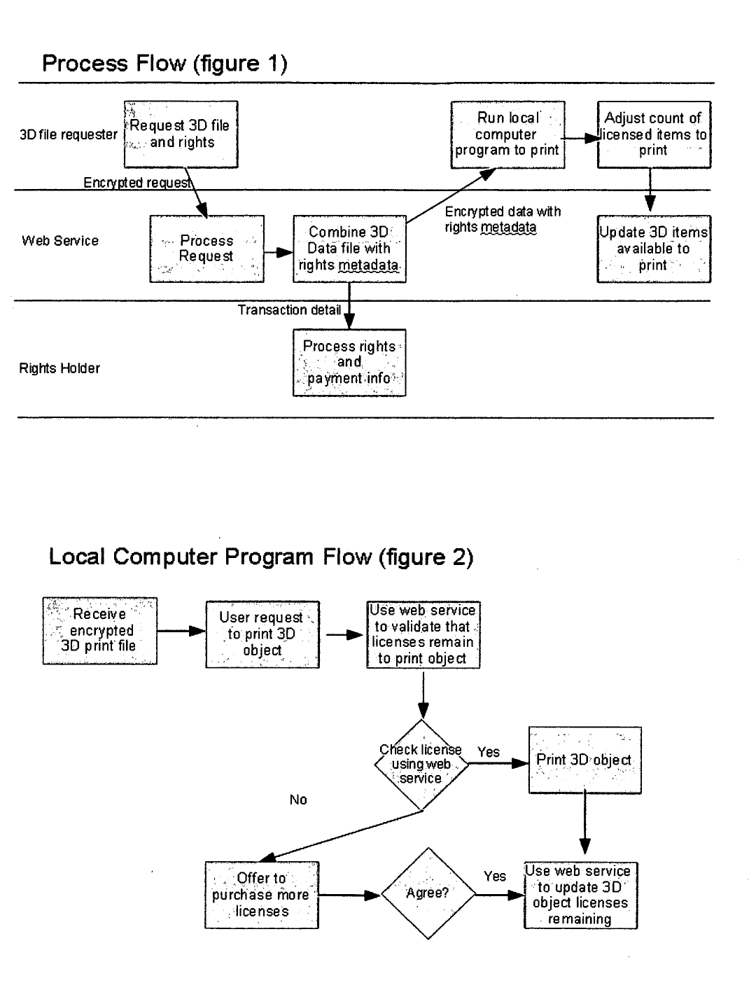

1. A system for transmitting data to support 3D printing of items and managing the digital rights for reproductions of the items on 3D printers, the system comprising:
(a) at least one web server available to select 3D items to be printed, and allowing the user to secure the rights to reproduce on a 3D printer one or more of the items modeled in the 3D file selected, and make payment for the same;
(b) client software running on a computer attached to a 3D printer that can use web services to contact the above noted web server to validate that the rights exist to reproduce the object on the attached 3D printer;
(c) One or more data files that contain the detailed computerized instructions for a 3D printer to print an item, and metadata indicating among other items, the purchaser of the rights to print, a digital serial number, print scale, and optionally a limit on number of 3D reproductions that are licensed for printing.

2. The system of claim 1 wherein data files supporting 3D printing can be purchased along with rights to reproduce those items which may be protected by trademark or other protection for which license may be granted.

3. The system of claim 1 wherein data files supporting 3D printing may be downloaded with metadata identifying who has purchased the rights to reproduce the item on a 3D printer, and identifying the computer system(s) which may print these items.

4. The system of claim 1 wherein a computer application running on a computer connected to a 3D printer or residing on the printer itself may examine a file defined in claim 3, and use network web services to determine if the 3D file may be printed based on the license information for the user of the application.

5. The system of claim 1 wherein a one or more web servers will allow the computer application of claim 4 to register itself as a 3D file consumer using a network web service.

6. The computer application of claim 4 wherein the application may register itself with the web service of claim 5, allowing this registered computer application to obtain 3D files of claim 3.

7. The computer application of claim 4 wherein the application will use web services to update the license information upon sending the print information to the 3D printer.

8. A method for securing on line payment for rights to reproduce 3D objects on a 3D printer

9. A method for disbursing payments using network web services to the holders of trademarks and other right holders for permission to reproduce 3D objects protected by them.
